(19) United States
(12) Patent Application Publication
(10) Pub. No.: US 2025/0096878 A1
(43) Pub. Date: Mar. 20, 2025

(54) FORWARDING OF SPATIALLY MULTIPLEXED COMMUNICATIONS HAVING MULTIPLE LAYERS PER POLARIZATION

(71) Applicant: QUALCOMM Incorporated, San Diego, CA (US)

(72) Inventors: Ahmed BEDEWY, Hillsborough, NJ (US); Juergen CEZANNE, Ocean Township, NJ (US); Meilong JIANG, Westfield, NJ (US); Ashwin SAMPATH, Skillman, NJ (US); Junyi LI, Fairless Hills, PA (US); Ozge KOYMEN, Princeton, NJ (US)

(21) Appl. No.: 18/468,229

(22) Filed: Sep. 15, 2023

(51) Int. Cl. H04B 7/06

(52) U.S. Cl. CPC H04B 7/06952

(57) ABSTRACT

Various aspects of the present disclosure generally relate to wireless communication. In some aspects, a network node may receive, via a set of reception antenna groups having a first antenna spacing that is independent from a distance between the network node and a transmitting device, signals associated with a spatially multiplexed communication having a first number of multiple layers per polarization. The network node may forward, via a set of transmission antenna groups having a second antenna spacing that is independent from a distance between the relay and a receiving device, the signals associated with the spatially multiplexed communication having a second number of multiple layers per polarization. Numerous other aspects are described.

### FIELD OF THE DISCLOSURE

Aspects of the present disclosure generally relate to wireless communication and to techniques and apparatuses for forwarding of spatially multiplexed communications having multiple layers per polarization.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a network node. The method may include receiving, via a set of reception antenna groups having a first antenna spacing that is independent from a distance between the network node and a transmitting device, signals associated with a spatially multiplexed communication having a first number of multiple layers per polarization. The method may include forwarding, via a set of transmission antenna groups having a second antenna spacing that is independent from a distance between the network node and a receiving device, the signals associated with the spatially multiplexed communication having a second number of multiple layers per polarization.

Some aspects described herein relate to a network node for wireless communication. The network node may include one or more memories and one or more processors coupled to the one or more memories. The one or more processors may be configured to cause the network node to receive, via a set of reception antenna groups having a first antenna spacing that is independent from a distance between the network node and a transmitting device, signals associated with a spatially multiplexed communication having a first number of multiple layers per polarization. The one or more processors may be configured to cause the network node to forward, via a set of transmission antenna groups having a second antenna spacing that is independent from a distance between the network node and a receiving device, the signals associated with the spatially multiplexed communication having a second number of multiple layers per polarization.

Some aspects described herein relate to a non-transitory computer-readable medium that stores a set of instructions for wireless communication by a network node. The set of instructions, when executed by one or more processors of the network node, may cause the network node to receive, via a set of reception antenna groups having a first antenna spacing that is independent from a distance between the network node and a transmitting device, signals associated with a spatially multiplexed communication having a first number of multiple layers per polarization. The set of instructions, when executed by one or more processors of the network node, may cause the network node to forward, via a set of transmission antenna groups having a second antenna spacing that is independent from a distance between the network node and a receiving device, the signals associated with the spatially multiplexed communication having a second number of multiple layers per polarization.

Some aspects described herein relate to an apparatus for wireless communication. The apparatus may include means for receiving, via a set of reception antenna groups having a first antenna spacing that is independent from a distance between the apparatus and a transmitting device, signals associated with a spatially multiplexed communication having a first number of multiple layers per polarization. The apparatus may include means for forwarding, via a set of transmission antenna groups having a second antenna spacing that is independent from a distance between the apparatus and a receiving device, the signals associated with the spatially multiplexed communication having a second number of multiple layers per polarization.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of line-of-sight (LOS) communication channels, in accordance with the present disclosure.

FIG. 5 is a diagram of an example associated with forwarding of spatially multiplexed communications having multiple layers per polarization, in accordance with the present disclosure.

FIG. 6 is a diagram of an example associated with forwarding of spatially multiplexed communications having multiple layers per polarization, in accordance with the present disclosure.

FIG. 7 is a diagram illustrating an example process performed, for example, at a network node or an apparatus of a network node, in accordance with the present disclosure.

FIG. 8 is a diagram of an example apparatus for wireless communication, in accordance with the present disclosure.

### DETAILED DESCRIPTION

In some wireless networks (e.g., using relatively high frequency bands), large antenna arrays for line-of-sight (LOS) communications may be used to increase channel capacities. For example, large antenna arrays may be used for LOS communication of a wireless fronthaul network. In some networks, network nodes may use multiple antennas to establish spatially multiplexed LOS communications over a direct path between a transmitting network node and a receiving network node.

However, as a distance between the transmitting network node and the receiving network node increases, a spatial multiplexing order decreases and performance decreases. Additionally, or alternatively, blockage and foliage may be challenges in LOS communications and may severely impact performance of communications.

In some networks, an amplify-and-forward (AF) relay may support communications between a transmitting network node and a receiving network node. The AF relay may amplify a received signal (e.g., transmitted by the transmitting network node) and forward it to the receiving network node. However, the AF relay may receive a communication on a single layer per polarization based at least in part on having a single spatial link to the transmitting network node and a single spatial link to the receiving network node. In this way, a spectral efficiency may be limited when using the AF relay.

Various aspects relate generally to forwarding of spatially multiplexed communications having multiple layers per polarization. Some aspects more specifically relate to a network node that operates as an AF relay. In some examples, a network node may receive signals associated with a spatially multiplexed communication having a first number of multiple layers per polarization and may forward the signals having a second number of multiple layers per polarization. In some aspects, the first number and the second number may be the same number. In some aspects, the network node may receive the spatially multiplexed communication via a set of reception antenna groups (e.g., subarrays) that maps to a set of transmission antenna groups (e.g., subarrays). For example, an input signal of a transmission antenna group may be a function of an output signal of a mapped reception antenna group of the network node. A function that may be applied to the output signal of the mapped reception antenna group may include phase shift, a delay, an amplification, and/or an attenuation, among other examples, which may be applied to the output signal of the mapped reception antenna group before providing the output signal of the mapped reception antenna group as the input signal of the transmission antenna group. Based at least in part on mapping the reception antenna groups to the transmission antenna groups, the network node can forward the spatially multiplexed communication as a forwarded spatially multiplexed communication.

Particular aspects of the subject matter described in this disclosure can be implemented to realize one or more of the following potential advantages. In some examples, by supporting forwarding a communication having multiple layers per polarization, the described techniques can be used to improve spectral efficiency by allowing spatial multiplexing of a communication.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

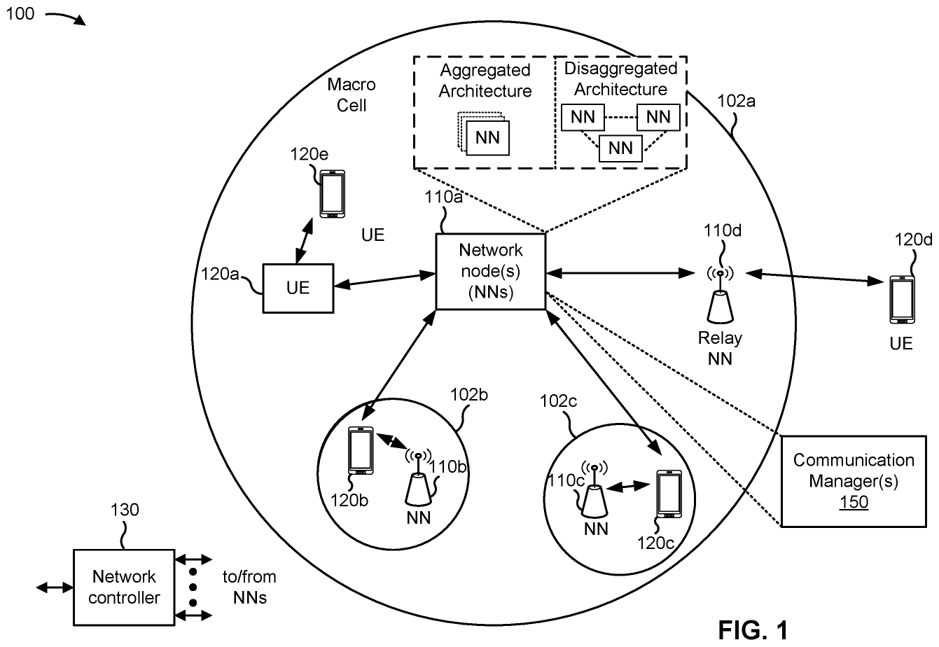

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHZ). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the network node 110 may include a communication manager 150. As described in more detail elsewhere herein, the communication manager 150 may receive, via a set of reception antenna groups having a first antenna spacing that is independent from a distance between the network node and a transmitting device, signals associated with a spatially multiplexed communication having a first number of multiple layers per polarization; and forward, via a set of transmission antenna groups having a second antenna spacing that is independent from a distance between the network node and a receiving device, the signals associated with the spatially multiplexed communication having a second number of multiple layers per polarization. Additionally, or alternatively, the communication manager 150 may perform one or more other operations described herein.

As indicated above, FIG. 1 is provided as an example. Other examples may differ from what is described with regard to FIG. 1.

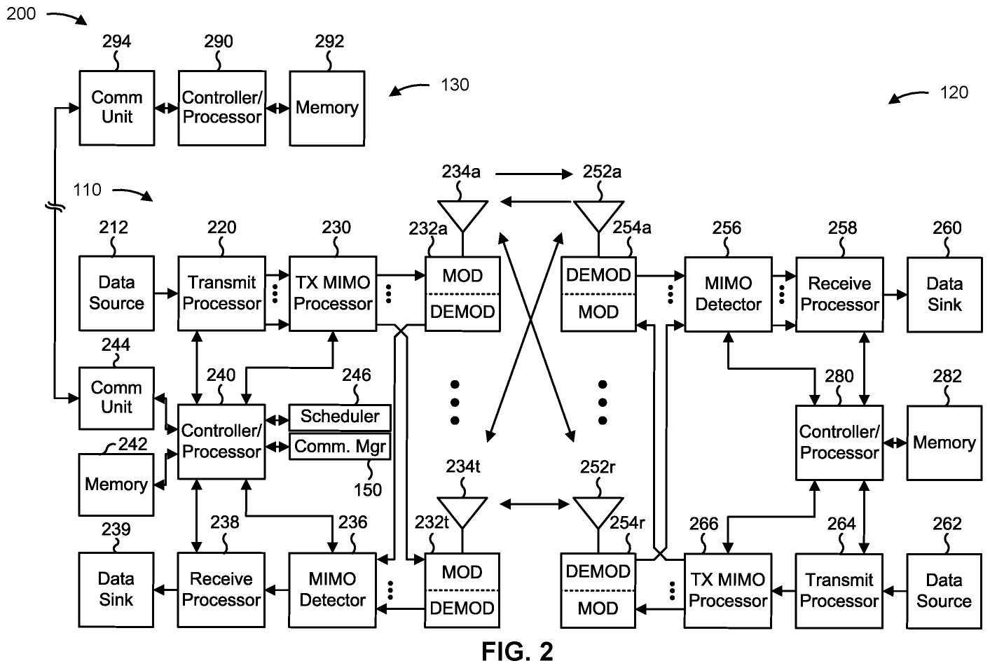

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

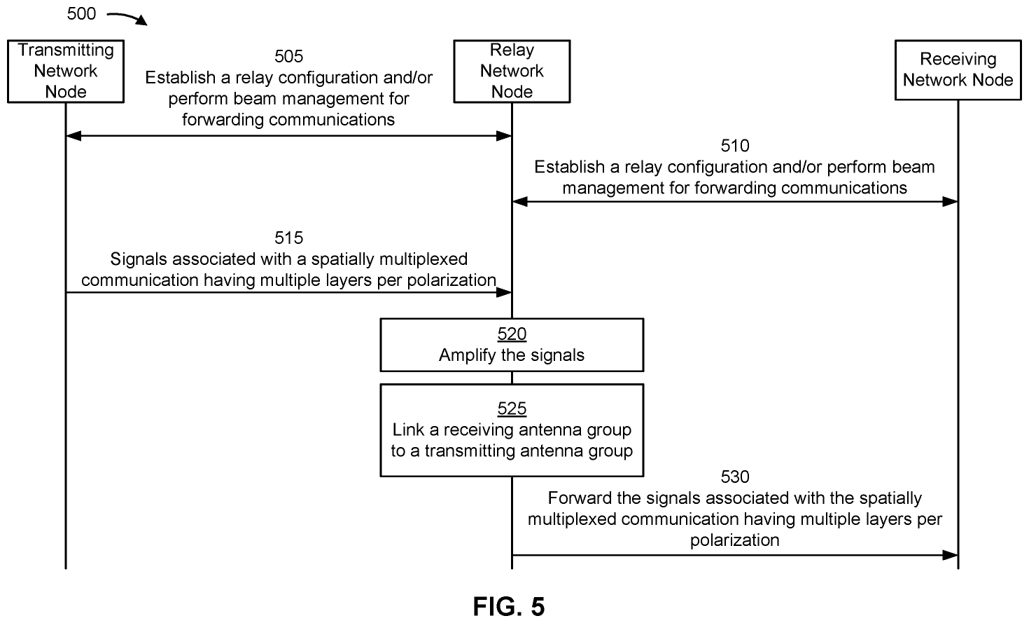

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-8).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-8).

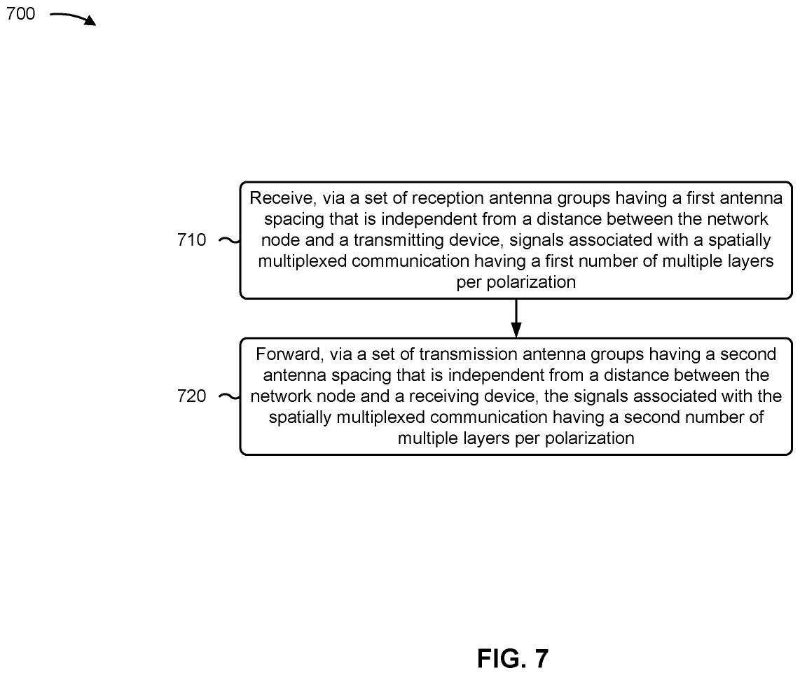

The controller/processor 240 of the network node 110, the controller/processor 280 of the UE 120, and/or any other component(s) of FIG. 2 may perform one or more techniques associated with forwarding of spatially multiplexed communications having multiple layers per polarization, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, and/or other processes as described herein. In some examples, executing instructions may include running the instructions, converting the instructions, compiling the instructions, and/or interpreting the instructions, among other examples.

In some aspects, the network node includes means for receiving, via a set of reception antenna groups having a first antenna spacing that is independent from a distance between the network node and a transmitting device, signals associated with a spatially multiplexed communication having a first number of multiple layers per polarization (e.g., using antenna 234, modem 232, MIMO detector 236, receive processor 238, controller/processor 240, and/or memory 242, among other examples); and/or means for forwarding, via a set of transmission antenna groups having a second antenna spacing that is independent from a distance between the network node and a receiving device, the signals associated with the spatially multiplexed communication having a second number of multiple layers per polarization (e.g., using controller/processor 240 and/or memory 242, among other examples). The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

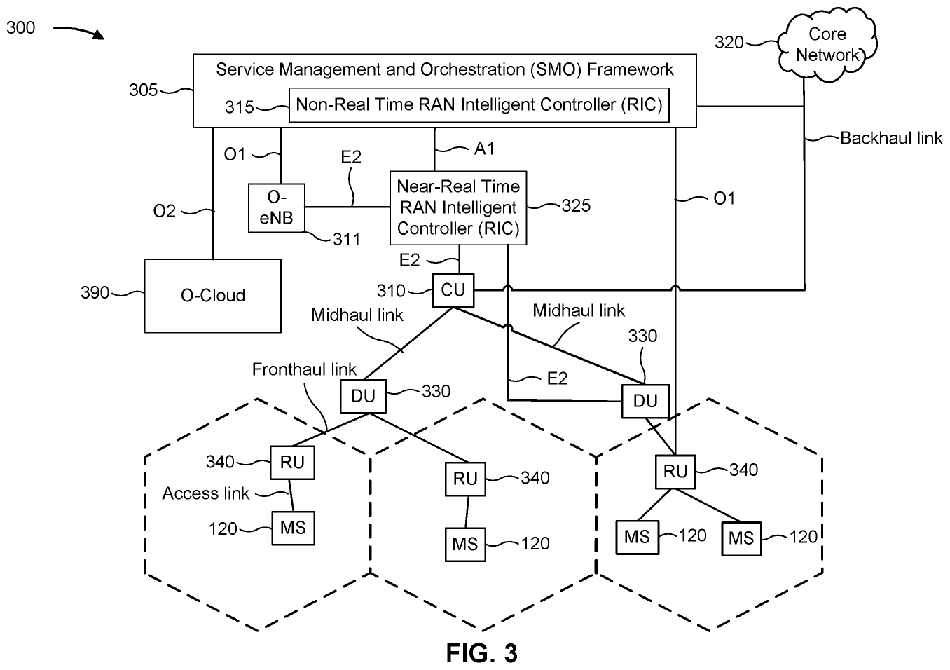

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310. DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

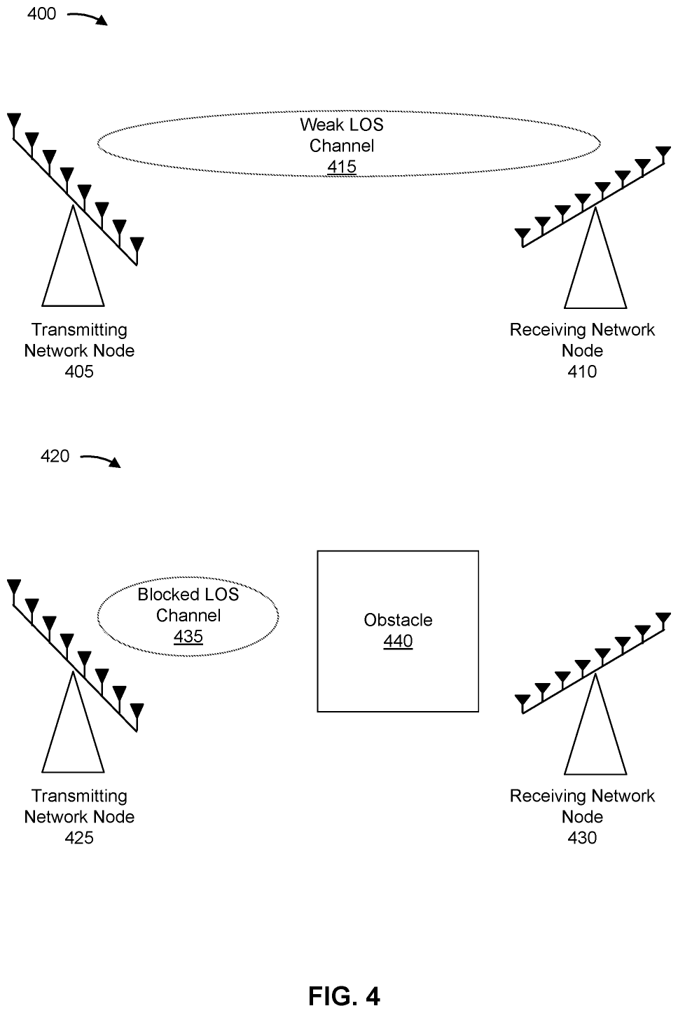

FIG. 4 is a diagram illustrating examples 400 and 420 of LOS communication channels, in accordance with the present disclosure. In some networks, a transmitting network node and a receiving network node may communicate via an LOS channel. In some networks, the transmitting network node and the receiving network node may be part of a backhaul network and/or may be stationary communication devices.

As shown in example 400, a transmitting network node 405 may communicate with a receiving network node 410 via a weak LOS channel 415. The weak LOS channel 415 may be associated with a signal-to-noise ratio (SNR) of communications transmitted by the transmitting network node 405 as received at the receiving network node 410. For example, the transmitting network node 405 and the receiving network node 410 may be spaced at a distance that is near, or outside of, a coverage edge of transmissions of the transmitting network node 405, which may cause a relatively low SNR (e.g., an SNR associated with a low modulation order or a high error rate). Based at least in part on having a weak LOS channel 415, transmissions from the transmitting network node 405 may use a low-efficiency MCS, the transmitting network node 405 may consume power resource to transmit signals with increased transmission power to improve SNR at the receiving network node 410. Additionally, or alternatively, the receiving network node 410 may consume power and/or processing resources to decode signals from the transmitting network node 405 with increased error correction. Further, the receiving network node 410 may receive communications with increased error rates, which may consume power, processing, network, and/or communication resources to detect and correct.

As shown in example 420, a transmitting network node 425 may attempt to communicate with a receiving network node 430 via a blocked LOS channel 435 that is blocked based at least in part on a presence of an obstacle 440. In some networks, the obstacle 440 may permanently block the blocked LOS channel 435, may periodically block the blocked LOS channel 435, or may aperiodically block the blocked LOS channel 435, among other examples. However, when the obstacle 440 is present, the transmitting network node 425 and the receiving network node 430 may not communicate via a LOS channel. This may cause communication failures while the obstacle 440 is present and/or may break a link between the transmitting network node 425 and the receiving network node 430, which may prevent any communication.

As indicated above, FIG. 4 is provided as an example. Other examples may differ from what is described with regard to FIG. 4.

In some aspects described herein, a network node may receive signals associated with a spatially multiplexed communication having a first number of multiple layers per polarization and may forward the signals having a second number of multiple layers per polarization. In some aspects, the first number and the second number may be the same number. In some aspects, the network node may receive the spatially multiplexed communication via a set of reception antenna groups (e.g., subarrays) that maps to a set of transmission antenna groups (e.g., subarrays). For example, an input signal of a transmission antenna group may be a function of an output signal of a mapped reception antenna group of the network node. A function that may be applied to the output signal of the mapped reception antenna group may include phase shift, a delay, an amplification, and/or an attenuation, among other examples, which may be applied to the output signal of the mapped reception antenna group before providing the output signal of the mapped reception antenna group as the input signal of the transmission antenna group. Based at least in part on mapping the reception antenna groups to the transmission antenna groups, the network node can forward the spatially multiplexed communication as a forwarded spatially multiplexed communication.

In some aspects, by supporting forwarding a communication having multiple layers per polarization, the described techniques can be used to improve spectral efficiency by allowing spatial multiplexing of a communication.

In some aspects, a network node may include an AF relay (e.g., a relay network node). The relay network node may support spatially multiplexed communication including multi-layer communications where a transmitting network node transmit a communication to the relay network node. The relay network node may amplify signals of the communication, as received from sub-arrays of the relay network node, and provide the signals to transmit sub-arrays for transmission to a receiving network node.

In some aspects, a rank (e.g., number of layers of a communication) of a channel between the transmitting network node and the relay network node may be associated with an aperture size of the transmitting network node, an available aperture size of receiving antenna groups of the relay network node, an equivalent isotropically radiated power (EIRP) of the transmitting network node, and/or a distance between the transmitting network node and the relay network node. Similarly, a rank of a channel between the relay network node and the receiving network node may be associated with an available aperture size of transmitting antenna groups of the relay network node, an aperture size of the receiving network node, an EIRP of the transmission antenna groups of the relay network node, and/or a distance between the relay network node and the receiving network node.

In some aspects, a location of the relay network node may be chosen such that a supported rank of the channel between the transmitting network node and the relay network node is the same as a supported rank of the channel between the relay network node and the receiving network node, or such that a difference between the supported rank of the channel between the transmitting network node and the relay network node and the supported rank of the channel between the relay network node and the receiving network node satisfies a threshold.

The number of antenna panels (antenna subarrays/antenna groups/antennas) in the relay (transmitter and receiver sides) should be at least equal to the minimum of the rank achieved by the Tx-relay channel and relay-Rx channel. In some aspects, the transmitting network node may be a DU or a CU and the receiving network node may be an RU. In some aspects, the transmitting network node and/or the receiving network node may be IAB nodes.

For an initial link establishment, a beam search procedure may be performed at both a link between the transmitting network node and the relay network node and a link between the relay network node and the receiving network node to identify appropriate beam link pairs for each link.

In some aspects, the relay network node may perform a forwarding operation that has relatively low complexity associated with avoiding signal processing in a baseband frequency before forwarding signals.

In some aspects, an achievable (e.g., maximum supported) number of layers L₁ by a first channel between the transmitting network node and the relay network node may be

$${L}_{1} = \frac{{a}_{t} {a}_{rr}}{λ {R}_{1}} ,$$

and an achievable number of layers L₂ between the relay network node and the receiving network node may be

$${L}_{2} = \frac{{a}_{tr} {a}_{r}}{λ {R}_{2}} .$$

λ may be a wavelength of signals transmitted via the channels, R₁ is a distance between the transmitting network node and the relay network node, and R₂ is a distance between the relay network node and the receiving network node. aₜ, aᵣ, aᵣᵣ, and aₜᵣ are aperture lengths of the transmitting network node, the receiving network node, a receiving antenna group of the relay network node, and a transmitting antenna group of the relay network node, respectively.

In some aspects, a network operator or other entity may select a location of the relay network node such that L=min (L₁, L₂) is maximized, where L is a maximum number of layers available between the transmitting network node and the receiving network node via the relay network node. For aᵣᵣ≥aᵣ and aₜᵣ≥aₜ. L may exceed a number of layers available without the relay network node, which is

$$\frac{{a}_{t} {a}_{r}}{λ ( {R}_{1} + {R}_{2} )} .$$

In an example network, the network includes the transmitting network node, the receiving network node, and the relay network node. The transmitting network node may transmit, to the relay network node, a signal via a spatially multiplexed communication with more than one layer per polarization. The relay network node may amplify and forward the signal, to the receiving network node, via a spatially multiplexed communication with more than one layer per polarization.

In some aspects, a transmission antenna array of the relay network node and a reception antenna array of the relay network node may include multiple antenna groups (e.g., sub-arrays). In some aspects, each reception antenna group of the relay network node may be connected to one or more transmission antenna groups of the relay network node. This connection may include, amplifiers, attenuators, phase shifters, delay elements, and/or adders, among other examples.

In some aspects, the relay network node may not convert the signal into an intermediate frequency or baseband frequency. In some aspects, the relay network node may not digitize the signal before forwarding the signal to the receiving network node.

In some aspects, a location of the relay network node may be such that a number of layers achieved between the transmitting network node and the relay network node and the number of layers achieved between the relay network node and the receiving network node have a difference that satisfies a threshold (e.g., equal to or less than the threshold). In some aspects, a number of relay antenna groups may be configured to support a minimum achieved rank between the transmitting network node and the relay network node, and a minimum achieved rank between the relay network node and the receiving network node.

In some aspects, the transmitting network node and the relay network node may select analog weight vectors (e.g., for steering beams for carrying the signal) for antenna groups used for communicating via an associated link. The analog weight vectors may be selected from a set of candidate analog weight vectors. Similarly, the relay network node and the receiving network node may select analog weight vectors for antenna groups used for communicating via an associated link. In some aspects, the analog weight vectors may be selected in association with a beam search procedure configured and/or directed by a network entity, with the beam search procedure indicated via messages among the network entity and the transmitting network node, the relay network node, and/or the receiving network node.

FIG. 5 is a diagram of an example 500 associated with forwarding of spatially multiplexed communications having multiple layers per polarization, in accordance with the present disclosure. As shown in FIG. 5, a transmitting network node (e.g., network node 110, an IAB node, a CU, a DU, and/or an RU) may communicate with a receiving network node (e.g., network node 110, an IAB node, a CU, a DU, and/or an RU) via a relay network node (e.g., an AF relay).

As shown by reference number 505, the transmitting network node and the relay network node may establish a relay configuration and/or may perform beam management for forwarding communications. In some aspects, the relay configuration may be associated with a maximum supported number of layers per polarization for communications from the transmitting network node to the relay network node. In some aspects, the maximum supported number of layers may be associated with an aperture size of the transmitting network node, an aperture size of the relay network node associated with reception antenna groups of the relay network node, an EIRP of the transmitting network node, and/or a distance between the relay network node and transmitting network node, among other examples. In some aspects, a supported number of layers per polarization may be independent from a distance between the transmitting network node and the relay network node.

In some aspects, the beam management may be associated with the transmitting network node selecting one or more transmission beams and the relay network node selecting one or more reception beams associated with the one or more transmission beams.

As shown by reference number 510, the receiving network node and the relay network node may establish a relay configuration and/or may perform beam management for forwarding communications. In some aspects, the relay configuration may be associated with a maximum supported number of layers per polarization for communications from the relay network node to the receiving network node. In some aspects, the maximum supported number of layers may be associated with an aperture size of transmission antenna groups of the relay network node, an aperture size of the receiving network node, an EIRP of the relay network node, and/or a distance between the relay network node and the receiving network node, among other examples. In some aspects, a supported number of layers per polarization may be independent from a distance between the relay network node and the receiving network node.

In some aspects, the beam management may be associated with the relay network node selecting one or more transmission beams and the receiving network node selecting one or more reception beams associated with the one or more transmission beams of the relay network node.

As shown by reference number 515, the transmitting network node may transmit, and the relay network node may receive, signals associated with a spatially multiplexed communication having multiple layers per polarization. In some aspects, the relay network node may receive the signals via a set of reception antenna groups having an antenna spacing that is independent from a distance between the relay network node and the transmitting network node. In some aspects, the set of reception antenna groups includes a number of antenna groups that is at least as large as a number of layers per polarization of the signal received from the transmitting network node.

In some aspects, the relay network node may receive the signals via two or more layers per polarization or via three or more layers per polarization.

In some aspects, the receiving network node may receive the signals based at least in part on applying an analog weight vector based at least in part on performing beam management, as described in connection with reference number 505.

As shown by reference number 520, the relay network node may amplify the signals. In some aspects, the relay network node may provide the signals to one or more devices within a transmission, reception, and/or processing chain to improve reception by the receiving network node. For example, the relay network node may apply, to the signals, a phase shift, a delay, amplification, addition (e.g., of an additional signal and/or pilots), and/or attenuation, among other examples. In some aspects, the relay network node may maintain the signals as analog signals while being processed within the relay network node. For example, the relay network node may not convert the signals to digital signals. In some aspects, the relay network node may leave the signals in a received frequency without converting the signals into an intermediate frequency or a baseband frequency.

As shown by reference number 525, the relay network node may link a receiving antenna group to a transmitting antenna group. For example, the relay network node may receive the signals from the transmitting network node via a first antenna group and a second antenna group. The relay network node may map the first antenna group to a third antenna group that is included in a set of transmission antenna groups, and may map the second antenna group to a fourth antenna group that is included in the set of transmission antenna groups. In this way, signals received via the first antenna group may be provided to the third antenna group for transmission and signals received via the second antenna group may be provided to the fourth antenna group for transmission.

In some aspects, the relay network node may link a set of receiving antenna groups to a set of transmitting antenna groups based at least in part on beam management between the transmitting network node and the relay network node, between the relay network node and the receiving network node, and/or between the transmitting network node and the receiving network node via the relay network node.

As shown by reference number 530, the relay network node may forward (e.g., transmit), and the receiving network node may receive, the signals associated with the spatially multiplexed communication having multiple layers per polarization. In some aspects, the relay network node may forward the signals via a set of transmission antenna groups having an antenna spacing that is independent from a distance between the relay network node and the receiving network node. In some aspects, the set of transmission antenna groups includes a number of antenna groups that is at least as large as a number of layers per polarization of the signal transmitted to the receiving network node.

In some aspects, the relay network node may transmit the signals based at least in part on applying an analog weight vector based at least in part on performing beam management, as described in connection with reference number 510.

In some aspects, the relay network node may transmit the signals via two or more layers per polarization or via three or more layers per polarization.

In some aspects, the relay network node may forward the signals with a same number of layers per polarization as a number of layers per polarization of the signals as received from the transmitting network node. In some aspects, the relay network node may forward the signals with a different number of layers per polarization from a number of layers per polarization of the signals as received from the transmitting network node. In some aspects, a difference in the number of layers per polarization may satisfy a threshold. In some aspects, the relay network node may be positioned at a location associated with minimizing the difference in the number of layers per polarization, or at a location that supports numbers of layers per polarization per link that satisfies the threshold.

In some aspects, the relay network node may include a number of reception antenna groups and a number of transmission antenna groups that are configured to support at least a minimum rank for communications between the transmitting network node and the receiving network node.

In some aspects, the antenna spacing of the set of reception antenna groups and the antenna spacing of the set of transmission antenna groups may be the same or may be different. For example, the antenna spacing may be the same based at least in part on using a modular manufacturing process where transmission antenna groups have the same, or generally the same, specifications for antenna spacing. In some aspects, antenna spacing may be different based at least in part on frequency ranges expected to be used for wireless communications with the transmitting device and for wireless communications with the receiving device (e.g., smaller spacing for higher frequency ranges).

Based at least in part on mapping the reception antenna groups to the transmission antenna groups, the relay network node can forward the spatially multiplexed communication as a forwarded spatially multiplexed communication. In some aspects, by supporting forwarding a communication having multiple layers per polarization, the described techniques can be used to improve spectral efficiency by allowing spatial multiplexing of a communication.

As indicated above, FIG. 5 is provided as an example. Other examples may differ from what is described with respect to FIG. 5.

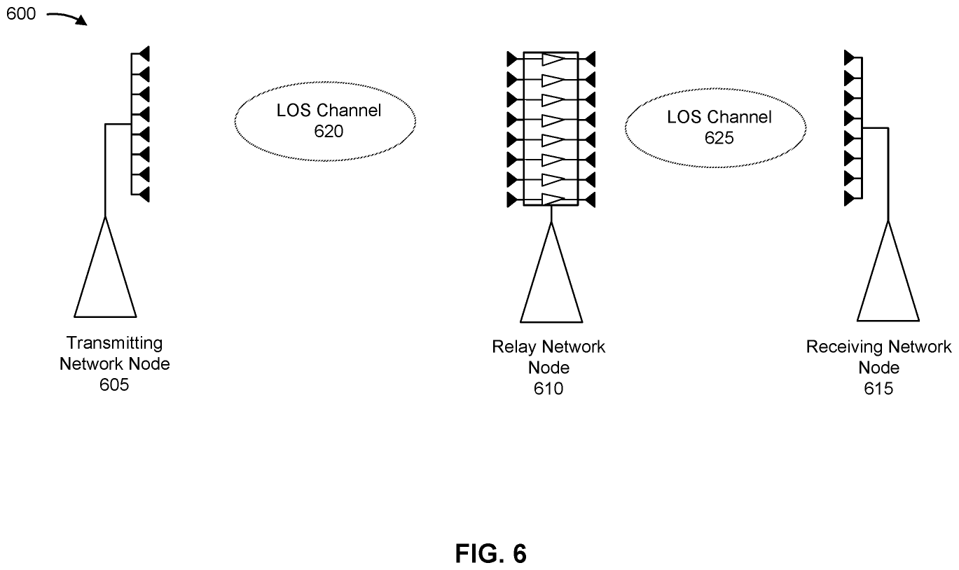

FIG. 6 is a diagram of an example 600 associated with forwarding of spatially multiplexed communications having multiple layers per polarization, in accordance with the present disclosure. As shown in FIG. 6, a transmitting network node 605 (e.g., network node 110, an IAB node, a CU, a DU, and/or an RU) may communicate via a relay network node 610 (e.g., an AF relay) with a receiving network node 615 (e.g., network node 110, an IAB node, a CU, a DU, and/or an RU).

As shown in FIG. 6, the transmitting network node 605 may communicate with the relay network node 610 via an LOS channel 620. The relay network node 610 may communicate with the receiving network node 615 via an LOS channel 625. As shown in FIG. 6, the relay network node 610 may include a set of reception antenna groups that map to transmission antenna groups, such that signals received from the transmitting network node 605 at the set of reception antenna groups may be provided to the set of transmission antenna groups for transmission to the receiving network node 615. In this way, the relay network node 610 may avoid digitizing the signals received from the transmitting network node 605 and/or may avoid converting the signals into a baseband frequency or an intermediate frequency, among other examples. In some aspects, the relay network node 610 may apply one or more effects to the signals before transmission, such as amplifying, phase shifting, delaying, amplifying, adding, or attenuating the signals, among other examples.

In some aspects, the relay network node 610 may be used to extend a coverage of the transmitting network node 605 and/or to avoid an obstruction that impedes a direct LOS link between the transmitting network node 605 and the receiving network node 615.

As indicated above, FIG. 6 is provided as an example. Other examples may differ from what is described with respect to FIG. 6.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with forwarding of spatially multiplexed communications having multiple layers per polarization.

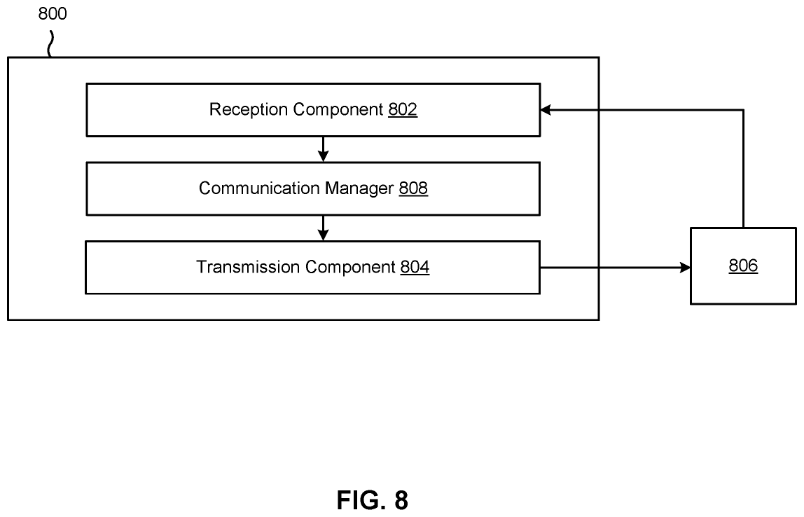

As shown in FIG. 7, in some aspects, process 700 may include receiving, via a set of reception antenna groups having a first antenna spacing that is independent from a distance between the network node and a transmitting device, signals associated with a spatially multiplexed communication having a first number of multiple layers per polarization (block 710). For example, the network node (e.g., using communication manager 150 and/or reception component 802, depicted in FIG. 8) may receive, via a set of reception antenna groups having a first antenna spacing that is independent from a distance between the network node and a transmitting device, signals associated with a spatially multiplexed communication having a first number of multiple layers per polarization, as described above, for example, with reference to FIGS. 5-6.

As further shown in FIG. 7, in some aspects, process 700 may include forwarding, via a set of transmission antenna groups having a second antenna spacing that is independent from a distance between the relay and a receiving device, the signals associated with the spatially multiplexed communication having a second number of multiple layers per polarization (block 720). For example, the network node (e.g., using communication manager 150 and/or transmission component 804, depicted in FIG. 8) may forward, via a set of transmission antenna groups having a second antenna spacing that is independent from a distance between the relay and a receiving device, the signals associated with the spatially multiplexed communication having a second number of multiple layers per polarization, as described above, for example, with reference to FIGS. 5-6.

Process 700 may include additional aspects, such as any single aspect or any combination of aspects described below and/or in connection with one or more other processes described elsewhere herein.

In a first aspect, the first number of multiple layers is equal to the second number of multiple layers, or the first number of multiple layers is different from the second number of multiple layers.

In a second aspect, alone or in combination with the first aspect, forwarding the signals comprises amplifying and forwarding the signals.

In a third aspect, alone or in combination with one or more of the first and second aspects, the first number of multiple layers per polarization comprises three or more layers per polarization, or the second number of multiple layers per polarization comprises three or more layers per polarization.

In a fourth aspect, alone or in combination with one or more of the first through third aspects, the set of reception antenna groups comprises a first antenna group and a second antenna group, the set of transmission antenna groups comprises a third antenna group and a fourth antenna group, and the first antenna group maps to the third antenna group and the second antenna group maps to the fourth antenna group.

In a fifth aspect, alone or in combination with one or more of the first through fourth aspects, forwarding the signals comprises applying one or more of a phase shift, a delay, amplification, addition, or attenuation.

In a sixth aspect, alone or in combination with one or more of the first through fifth aspects, the first number of multiple layers is associated with one or more of an aperture size of a wireless communication device that transmitted the signals to the network node, an aperture size of reception antenna groups of the network node, an EIRP of the wireless communication device that transmitted the signals to the network node, or a distance between the network node and the wireless communication device that transmitted the signals to the network node.

In a seventh aspect, alone or in combination with one or more of the first through sixth aspects, the second number of multiple layers is associated with one or more of the first number of multiple layers, an aperture size of transmission antenna groups of the network node, an aperture size of a wireless communication device that receives the signals from the network node, an EIRP of the network node, or a distance between the network node and the wireless communication device that receives the signals from the network node.

In an eighth aspect, alone or in combination with one or more of the first through seventh aspects, the network node is positioned at a location associated with a first number of supported numbers of multiple layers per polarization for receiving from a first wireless communication device (WCD), the location is associated with a second number of supported numbers of multiple layers per polarization for transmitting to a second WCD, and the first number and the second number have a difference that satisfies a threshold.

In a ninth aspect, alone or in combination with one or more of the first through eighth aspects, the set of reception antenna groups includes a first number of antenna groups that is at least as large as the first number of multiple layers per polarization, and the set of transmission antenna groups includes a second number of antenna groups that is at least as large as the second number of multiple layers per polarization.

In a tenth aspect, alone or in combination with one or more of the first through ninth aspects, process 700 includes performing first beam management with a first WCD that transmits the signals to the network node, and performing second beam management with a second WCD that receives the signals from the network node, wherein the set of reception antenna groups is mapped to the set of transmission antenna groups based at least in part on performing the first beam management and the second beam management.

In an eleventh aspect, alone or in combination with one or more of the first through tenth aspects, receiving and forwarding the signals comprises maintaining the signals as analog signals, and leaving the signals in a received frequency without converting to an intermediate frequency or a baseband frequency.

In a twelfth aspect, alone or in combination with one or more of the first through eleventh aspects, receiving the signals comprises applying a first analog weight vector associated with receiving the signals from a first WCD, and transmitting the signals comprises applying a second analog weight vector associated with transmitting the signals to a second WCD.

In a thirteenth aspect, alone or in combination with one or more of the first through twelfth aspects, a number of antenna groups of the set of reception antenna groups and the set of transmission antenna groups is associated with support for at least a minimum rank for communications between a first WCD associated with transmitting the signals to the network node and a second WCD associated with receiving the signals from the network node.

In a fourteenth aspect, alone or in combination with one or more of the first through thirteenth aspects, a supported first number of layers per polarization is independent from a first distance between the network node and a transmitting device, first distance satisfies a first threshold, a supported second number of layers per polarization is independent from a second distance between the network node and a receiving device, and the second distance satisfies a second threshold.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a network node, or a network node may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 5-6. Additionally, or alternatively, the apparatus 800 may be configured to perform one or more processes described herein, such as process 700 of FIG. 7. In some aspects, the apparatus 800 and/or one or more components shown in FIG. 8 may include one or more components of the network node described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 802 and/or the transmission component 804 may include or may be included in a network interface. The network interface may be configured to obtain and/or output signals for the apparatus 800 via one or more communications links, such as a backhaul link, a midhaul link, and/or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 804 may be co-located with the reception component 802 in one or more transceivers.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive, via a set of reception antenna groups having a first antenna spacing that is independent from a distance between the network node and a transmitting device, signals associated with a spatially multiplexed communication having a first number of multiple layers per polarization. The communication manager 806 may forward, via a set of transmission antenna groups having a second antenna spacing that is independent from a distance between the relay and a receiving device, the signals associated with the spatially multiplexed communication having a second number of multiple layers per polarization.

The communication manager 806 may perform first beam management with a first WCD that transmits the signals to the network node (e.g., a transmitting network node).

The communication manager 806 may perform second beam management with a second WCD that receives the signals from the network node wherein the set of reception antenna groups is mapped to the set of transmission antenna groups based at least in part on performing the first beam management and the second beam management.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by a network node, comprising: receiving, via a set of reception antenna groups having a first antenna spacing that is independent from a distance between the network node and a transmitting device, signals associated with a spatially multiplexed communication having a first number of multiple layers per polarization; and forwarding, via a set of transmission antenna groups having a second antenna spacing that is independent from a distance between the relay and a receiving device, the signals associated with the spatially multiplexed communication having a second number of multiple layers per polarization.
Aspect 2: The method of Aspect 1, wherein the first number of multiple layers is equal to the second number of multiple layers, or wherein the first number of multiple layers is different from the second number of multiple layers.
Aspect 3: The method of any of Aspects 1-2, wherein forwarding the signals comprises amplifying and forwarding the signals.
Aspect 4: The method of any of Aspects 1-3, wherein the first number of multiple layers per polarization comprises three or more layers per polarization, or wherein the second number of multiple layers per polarization comprises three or more layers per polarization.
Aspect 5: The method of any of Aspects 1-4, wherein the set of reception antenna groups comprises a first antenna group and a second antenna group, wherein the set of transmission antenna groups comprises a third antenna group and a fourth antenna group, and wherein the first antenna group maps to the third antenna group and the second antenna group maps to the fourth antenna group.
Aspect 6: The method of any of Aspects 1-5, wherein forwarding the signals comprises applying one or more of: a phase shift, a delay, amplification, addition, or attenuation.
Aspect 7: The method of any of Aspects 1-6, wherein the first number of multiple layers is associated with one or more of: an aperture size of a wireless communication device that transmitted the signals to the network node, an aperture size of reception antenna groups of the network node, an equivalent isotropically radiated power (EIRP) of the wireless communication device that transmitted the signals to the network node, or a distance between the network node and the wireless communication device that transmitted the signals to the network node.
Aspect 8: The method of any of Aspects 1-7, wherein the second number of multiple layers is associated with one or more of: the first number of multiple layers, an aperture size of transmission antenna groups of the network node, an aperture size of a wireless communication device that receives the signals from the network node, an equivalent isotropically radiated power (EIRP) of the network node, or a distance between the network node and the wireless communication device that receives the signals from the network node.
Aspect 9: The method of any of Aspects 1-8, wherein the network node is positioned at a location associated with a first number of supported numbers of multiple layers per polarization for receiving from a first wireless communication device (WCD), wherein the location is associated with a second number of supported numbers of multiple layers per polarization for transmitting to a second WCD, and wherein the first number and the second number have a difference that satisfies a threshold.
Aspect 10: The method of any of Aspects 1-9, wherein the set of reception antenna groups includes a first number of antenna groups that is at least as large as the first number of multiple layers per polarization, and wherein the set of transmission antenna groups includes a second number of antenna groups that is at least as large as the second number of multiple layers per polarization.
Aspect 11: The method of any of Aspects 1-10, further comprising: performing first beam management with a first wireless communication device (WCD) that transmits the signals to the network node; and performing second beam management with a second WCD that receives the signals from the network node, wherein the set of reception antenna groups is mapped to the set of transmission antenna groups based at least in part on performing the first beam management and the second beam management.
Aspect 12: The method of any of Aspects 1-11, wherein receiving and forwarding the signals comprises: maintaining the signals as analog signals, and leaving the signals in a received frequency without converting to an intermediate frequency or a baseband frequency.
Aspect 13: The method of any of Aspects 1-12, wherein receiving the signals comprises applying a first analog weight vector associated with receiving the signals from a first wireless communication device (WCD), and wherein transmitting the signals comprises applying a second analog weight vector associated with transmitting the signals to a second WCD.
Aspect 14: The method of any of Aspects 1-13, wherein a number of antenna groups of the set of reception antenna groups and the set of transmission antenna groups is associated with support for at least a minimum rank for communications between a first wireless communication device (WCD) associated with transmitting the signals to the network node and a second WCD associated with receiving the signals from the network node.
Aspect 15: The method of any of Aspects 1-14, wherein a supported first number of layers per polarization is independent from a first distance between the network node and a transmitting device, wherein first distance satisfies a first threshold, wherein a supported second number of layers per polarization is independent from a second distance between the network node and a receiving device, and wherein the second distance satisfies a second threshold.
Aspect 16: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-15.
Aspect 17: An apparatus for wireless communication at a device, the apparatus comprising one or more memories and one or more processors coupled to the one or more memories, the one or more processors configured to cause the device to perform the method of one or more of Aspects 1-15.
Aspect 18: An apparatus for wireless communication, the apparatus comprising at least one means for performing the method of one or more of Aspects 1-15.
Aspect 19: A non-transitory computer-readable medium storing code for wireless communication, the code comprising instructions executable by one or more processors to perform the method of one or more of Aspects 1-15.
Aspect 20: A non-transitory computer-readable medium storing a set of instructions for wireless communication, the set of instructions comprising one or more instructions that, when executed by one or more processors of a device, cause the device to perform the method of one or more of Aspects 1-15.
Aspect 21: A device for wireless communication, the device comprising a processing system that includes one or more processors and one or more memories coupled with the one or more processors, the processing system configured to cause the device to perform the method of one or more of Aspects 1-15.
Aspect 22: An apparatus for wireless communication at a device, the apparatus comprising one or more memories and one or more processors coupled to the one or more memories, the one or more processors individually or collectively configured to cause the device to perform the method of one or more of Aspects 1-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network node for wireless communication, comprising:
one or more memories; and
one or more processors, coupled to the one or more memories, configured to cause the network node to:
receive, via a set of reception antenna groups having a first antenna spacing that is independent from a distance between the network node and a transmitting device, signals associated with a spatially multiplexed communication having a first number of multiple layers per polarization; and
forward, via a set of transmission antenna groups having a second antenna spacing that is independent from a distance between the network node and a receiving device, the signals associated with the spatially multiplexed communication having a second number of multiple layers per polarization.

2. The network node of claim 1, wherein the first number of multiple layers is equal to the second number of multiple layers, or
wherein the first number of multiple layers is different from the second number of multiple layers.

3. The network node of claim 1, wherein the one or more processors, to cause the network node to forward the signals, are configured to cause the network node to amplify and forwarding the signals.

4. The network node of claim 1, wherein the first number of multiple layers per polarization comprises three or more layers per polarization, or
wherein the second number of multiple layers per polarization comprises three or more layers per polarization.

5. The network node of claim 1, wherein the set of reception antenna groups comprises a first antenna group and a second antenna group,
wherein the set of transmission antenna groups comprises a third antenna group and a fourth antenna group, and
wherein the first antenna group maps to the third antenna group and the second antenna group maps to the fourth antenna group.

6. The network node of claim 1, wherein the one or more processors, to cause the network node to forward the signals, are configured to cause the network node to apply one or more of:
a phase shift,
a delay,
amplification,
addition, or
attenuation.

7. The network node of claim 1, wherein the first number of multiple layers is associated with one or more of:
an aperture size of a wireless communication device that transmitted the signals to the network node,
an aperture size of the reception antenna groups of the network node,
an equivalent isotropically radiated power (EIRP) of the wireless communication device that transmitted the signals to the network node, or
a distance between the network node and the wireless communication device that transmitted the signals to the network node.

8. The network node of claim 1, wherein the second number of multiple layers is associated with one or more of:
the first number of multiple layers,
an aperture size of the network node associated with the transmission antenna groups,
an aperture size of a wireless communication device that receives the signals from the network node,
an equivalent isotropically radiated power (EIRP) of the network node, or
a distance between the network node and the wireless communication device that receives the signals from the network node.

9. The network node of claim 1, wherein the network node is positioned at a location associated with a first number of supported numbers of multiple layers per polarization for receiving from a first wireless communication device (WCD),
wherein the location is associated with a second number of supported numbers of multiple layers per polarization for transmitting to a second WCD, and
wherein the first number and the second number have a difference that satisfies a threshold.

10. The network node of claim 1, wherein the set of reception antenna groups includes a first number of antenna groups that is at least as large as the first number of multiple layers per polarization, and
wherein the set of transmission antenna groups includes a second number of antenna groups that is at least as large as the second number of multiple layers per polarization.

11. The network node of claim 1, wherein the one or more processors are further configured to cause the network node to:
perform first beam management with a first wireless communication device (WCD) that transmits the signals to the network node; and
perform second beam management with a second WCD that receives the signals from the network node,
wherein the set of reception antenna groups is mapped to the set of transmission antenna groups based at least in part on performing the first beam management and the second beam management.

12. The network node of claim 1, wherein the one or more processors, to cause the network node to receive and forwarding the signals, are configured to cause the network node to:
maintain the signals as analog signals, and
leave the signals in a received frequency without converting to an intermediate frequency or a baseband frequency.

13. The network node of claim 1, wherein the one or more processors, to cause the network node to receive the signals, are configured to cause the network node to apply a first analog weight vector associated with receiving the signals from a first wireless communication device (WCD), and
wherein the one or more processors, to cause the network node to transmit the signals, are configured to cause the network node to apply a second analog weight vector associated with transmitting the signals to a second WCD.

14. The network node of claim 1, wherein a number of antenna groups of the set of reception antenna groups and the set of transmission antenna groups is associated with support for at least a minimum rank for communications between a first wireless communication device (WCD) associated with transmitting the signals to the network node and a second WCD associated with receiving the signals from the network node.

15. The network node of claim 1, wherein a supported first number of layers per polarization is independent from a first distance between the network node and a transmitting device,
wherein first distance satisfies a first threshold,
wherein a supported second number of layers per polarization is independent from a second distance between the network node and a receiving device, and
wherein the second distance satisfies a second threshold.

16. A method of wireless communication performed by a network node, comprising:
receiving, via a set of reception antenna groups having a first antenna spacing that is independent from a distance between the network node and a transmitting device, signals associated with a spatially multiplexed communication having a first number of multiple layers per polarization; and
forwarding, via a set of transmission antenna groups having a second antenna spacing that is independent from a distance between the network node and a receiving device, the signals associated with the spatially multiplexed communication having a second number of multiple layers per polarization.

17. The method of claim 16, wherein the first number of multiple layers per polarization comprises three or more layers per polarization, or
wherein the second number of multiple layers per polarization comprises three or more layers per polarization.

18. The method of claim 16, wherein the set of reception antenna groups comprises a first antenna group and a second antenna group,
wherein the set of transmission antenna groups comprises a third antenna group and a fourth antenna group, and
wherein the first antenna group maps to the third antenna group and the second antenna group maps to the fourth antenna group.

19. The method of claim 16, wherein forwarding the signals comprises applying one or more of:
a phase shift,
a delay,
amplification,
addition, or
attenuation.

20. The method of claim 16, wherein the first number of multiple layers is associated with one or more of:
an aperture size of a wireless communication device that transmitted the signals to the network node,
an aperture size of reception antenna groups of the network node,
an equivalent isotropically radiated power (EIRP) of the wireless communication device that transmitted the signals to the network node, or
a distance between the network node and the wireless communication device that transmitted the signals to the network node.

21. The method of claim 16, wherein the second number of multiple layers is associated with one or more of:
the first number of multiple layers,
an aperture size of transmission antenna groups of the network node,
an aperture size of a wireless communication device that receives the signals from the network node,
an equivalent isotropically radiated power (EIRP) of the network node, or
a distance between the network node and the wireless communication device that receives the signals from the network node.

22. The method of claim 16, wherein the network node is positioned at a location associated with a first number of supported numbers of multiple layers per polarization for receiving from a first wireless communication device (WCD),
wherein the location is associated with a second number of supported numbers of multiple layers per polarization for transmitting to a second WCD, and
wherein the first number and the second number have a difference that satisfies a threshold.

23. The method of claim 16, wherein the set of reception antenna groups includes a first number of antenna groups that is at least as large as the first number of multiple layers per polarization, and
wherein the set of transmission antenna groups includes a second number of antenna groups that is at least as large as the second number of multiple layers per polarization.

24. The method of claim 16, further comprising:
performing first beam management with a first wireless communication device (WCD) that transmits the signals to the network node; and
performing second beam management with a second WCD that receives the signals from the network node,
wherein the set of reception antenna groups is mapped to the set of transmission antenna groups based at least in part on performing the first beam management and the second beam management.

25. The method of claim 16, wherein receiving and forwarding the signals comprises:
maintaining the signals as analog signals, and
leaving the signals in a received frequency without converting to an intermediate frequency or a baseband frequency.

26. The method of claim 16, wherein receiving the signals comprises applying a first analog weight vector associated with receiving the signals from a first wireless communication device (WCD), and
wherein transmitting the signals comprises applying a second analog weight vector associated with transmitting the signals to a second WCD.

27. The method of claim 16, wherein a number of antenna groups of the set of reception antenna groups and the set of transmission antenna groups is associated with support for at least a minimum rank for communications between a first wireless communication device (WCD) associated with transmitting the signals to the network node and a second WCD associated with receiving the signals from the network node.

28. The method of claim 16, wherein a supported first number of layers per polarization is independent from a first distance between the network node and a transmitting device,
wherein first distance satisfies a first threshold,
wherein a supported second number of layers per polarization is independent from a second distance between the network node and a receiving device, and
wherein the second distance satisfies a second threshold.

29. A non-transitory computer-readable medium storing a set of instructions for wireless communication, the set of instructions comprising:
one or more instructions that, when executed by one or more processors of a network node, cause the network node to:
receive, via a set of reception antenna groups having a first antenna spacing that is independent from a distance between the network node and a transmitting device, signals associated with a spatially multiplexed communication having a first number of multiple layers per polarization; and
forward, via a set of transmission antenna groups having a second antenna spacing that is independent from a distance between the network node and a receiving device, the signals associated with the spatially multiplexed communication having a second number of multiple layers per polarization.

30. An apparatus for wireless communication, comprising:
means for receiving, via a set of reception antenna groups having a first antenna spacing that is independent from a distance between the apparatus and a transmitting device, signals associated with a spatially multiplexed communication having a first number of multiple layers per polarization; and
means for forwarding, via a set of transmission antenna groups having a second antenna spacing that is independent from a distance between the apparatus and a receiving device, the signals associated with the spatially multiplexed communication having a second number of multiple layers per polarization.
